(19) United States
(12) Patent Application Publication
(10) Pub. No.: US 2017/0201166 A1
(43) Pub. Date: Jul. 13, 2017

(54) ELECTRIC MOTOR AND ELECTRICAL APPARATUS COMPRISING SAME

(71) Applicant: Panasonic Intellectual Property Management Co., Ltd., Osaka (JP)

(72) Inventors: Takashi OGAWA, Osaka (JP); Yuichi YOSHIKAWA, Osaka (JP); Haruhiko KADO, Osaka (JP); Yukihiro OKADA, Osaka (JP); Hiroshi UEDA, Kyoto (JP); Shin'ichi TSUTSUMI, Kyoto (JP)

(21) Appl. No.: 15/326,012

(22) PCT Filed: Sep. 7, 2015
(86) PCT No.: PCT/JP2015/004513

§ 371 Date: Jan. 12, 2017

(30) Foreign Application Priority Data
Sep. 17, 2014 (JP) 2014-188956

(51) Int. Cl. H02K 21/14; H02K 11/30; H02K 7/08; H02K 1/27; H02K 1/14

(52) U.S. Cl. CPC H02K 21/14; H02K 1/2706; H02K 1/146; H02K 7/083; H02K 11/30

(57) ABSTRACT

Electric motor (100) according to the present invention includes stator (40), rotor (10), and a pair of bearings (30). Stator (40) has stator core (41) which is annularly formed. Rotor (10) is located on the inner circumferential side of stator core (41), and includes shaft (12), rotor core (11), and bonded magnets (14). Bonded magnets (14) are filled in magnet holes (13). Bonded magnets (14) are formed with high density portion (14b) having a high density and low density portion (14c) having a density lower than high density portion (14b). In electric motor (100), center position (11b) of rotor core (11) is located on the side where high density portion (14b) is present with respect to center position (41b) of stator core (41) in the direction of shaft center (12a) of shaft (12).

### TECHNICAL FIELD

The present invention relates to an electric motor including an interior permanent magnet rotor, which has a plurality of permanent magnets filled in a rotor core with a predetermined gap therebetween, and an electrical apparatus including the electric motor.

### BACKGROUND ART

Conventionally, an electric motor using a permanent magnet includes a rotor provided on an inner circumference of a stator with a gap.

The stator has substantially a cylindrical shape, and generates a rotating magnetic field.

The rotor includes a shaft and a rotor core. A magnetic pole is formed on the rotor by the permanent magnet provided to the rotor core. The rotor rotates around the shaft.

The permanent magnet is used as a part of the rotor core of the rotor. Specifically, a magnet hole into which the permanent magnet is inserted is formed on the rotor core. A small piece of a permanent magnet is inserted into the magnet hole.

An electric motor in which a permanent magnet is embedded into a rotor core as in the configuration described above is also referred to as an interior permanent magnet (IPM) motor.

An interior permanent magnet rotor is widely used for a rotor for accomplishing the following objectives.

Specifically, the first one of the objectives to be accomplished is to ensure the rigidity of a rotor against centrifugal force applied to the rotor while the rotor rotates at high speed.

The second one of the objectives to be accomplished is to generate magnetic saliency on a rotor by inserting a permanent magnet into a rotor core. If the magnetic saliency is generated on the rotor, rotary torque is generated on the rotor. The rotary torque includes reluctance torque as well as magnetic torque.

A small piece of an Nd—Fe—B sintered magnet or a small piece of a ferrite sintered magnet has been widely used for a permanent magnet.

In the case where a small piece of a permanent magnet is used, a magnet hole formed on a rotor core is formed with a size slightly larger than the outer shape of the small piece of the permanent magnet. If the magnet hole has a size slightly larger than the outer shape of the small piece of the permanent magnet, workability in assembling the rotor is enhanced. The reason of the enhancement in workability is as stated below.

Specifically, the magnet hole formed on the rotor core is formed through a process for working a metal. The process for working a metal is referred to as a metal working process below. Therefore, the magnet hole is formed with high-precise working, and thus, a dimensional tolerance is small.

On the other hand, the small piece of the permanent magnet described above is formed through a process for sintering magnet powders or the like. The process for sintering magnet powders or the like is referred to as a sintering process below. The sintering process is similar to a process for firing ceramics or the like in a kiln. Accordingly, a small piece of a permanent magnet which has been subjected to the sintering process may sometimes be deformed, e.g., may be warped or deflected. If the small piece of the permanent magnet is subjected to a process for grinding the small piece with a grind stone or the like, the deformation occurring on the small piece of the permanent magnet can be eliminated. The process for grinding the small piece with a grind stone or the like is referred to as a grinding process below.

An electric motor does not employ a grinding process for eliminating deformation on a small piece of a permanent magnet. Alternatively, even if a grinding process is employed for an electric motor, an amount to be ground of a small piece of a permanent magnet is very small. In addition, precision in grinding a small piece of a permanent magnet is low.

Accordingly, as described above, an electric motor addresses deformation on a small piece of a permanent magnet by setting a magnet hole to be slightly larger than the outer shape of the small piece of the permanent magnet. It is to be noted that, when the grinding process is employed, the following problems arise. Specifically, the problems include the need of facility and an increase in the number of working processes.

However, in the case where the magnet hole is set to be slightly larger than the outer shape of the small piece of the permanent magnet, a gap is generated between the rotor core and the small piece of the permanent magnet. The gap between the rotor core and the small piece of the permanent magnet acts as magnetic resistance. Therefore, magnetic flux density generated on the surface of the rotor decreases.

Further, a small piece of a permanent magnet formed of an Nd—Fe—B sintered magnet or a ferrite sintered magnet has characteristics of being hard and fragile, like ceramics. In view of this, a small piece of a permanent magnet cannot be formed to have a complex shape.

Specifically, the following shape is employed for a small piece of a permanent magnet. That is, a small piece of a permanent magnet is a columnar body with a rectangular cross-section. The columnar body with a rectangular cross-section is a planar plate. Alternatively, a small piece of a permanent magnet is a columnar body with a trapezoidal cross-section. A small piece of a permanent magnet is a columnar body with an arc cross-section. The columnar body with an arc cross-section is a plate having substantially a U shaped cross section.

Any of the small pieces of permanent magnets formed through the above molding process has a large dimension tolerance. Therefore, when the small pieces of the permanent magnets are used, a gap is formed between the rotor core and the used small piece of the permanent magnet.

To address this problem, Patent Literature 1 discloses an interior permanent magnet rotor in which, after a small piece of a permanent magnet having high energy density is inserted into a magnet hole, a mixture constituting a bonded magnet is filled in the magnet hole. In the interior permanent magnet rotor, the mixture constituting the bonded magnet enters in the gap between the small piece of the permanent magnet and the magnet hole. The mixture which constitutes the bonded magnet and enters in the gap eliminates the magnetic resistance caused by the gap. Accordingly, the magnetic flux density generated from the interior permanent magnet rotor is enhanced.

Meanwhile, a relative magnetic permeability of an Nd—Fe—B sintered magnet or a ferrite sintered magnet is almost the same as the relative magnetic permeability of air. The relative magnetic permeability of each of these materials is slightly larger than 1.0. Similarly, a relative magnetic permeability of a bonded magnet including powders of an Nd—Fe—B sintered magnet or a bonded magnet including powders of a ferrite sintered magnet is also almost the same as the relative magnetic permeability of air. The relative magnetic permeability of each of these bonded magnets is also slightly larger than 1.0.

In other words, a bonded magnet including powders of an Nd—Fe—B sintered magnet or a bonded magnet including powders of a ferrite sintered magnet is equivalent to a layer of air. Therefore, even if the bonded magnet described above is filled in the gap between the small piece of the permanent magnet and the magnet hole, the increase in the magnetic flux density generated from the interior permanent magnet rotor cannot be expected.

Further, a mixture entering in the gap between the small piece of the permanent magnet and the magnet hole has a small thickness. Even when the mixture constituting the bonded magnet is magnetized in the direction of this small thickness, magnetic force obtained from the mixture is very small. This is because the mixture constituting the bonded magnet is largely affected by a diamagnetic field. That is, the magnetic force of the mixture entering in the gap between the small piece of the permanent magnet and the magnet hole hardly contributes to the increase in the magnetic flux density generated from the interior permanent magnet rotor.

If a bonded magnet or a bonded magnetic body having a relative magnetic permeability larger than the relative magnetic permeability of air is used, the magnetic flux density generated from the interior permanent magnet rotor is expected to be increased. In the description below, a bonded magnet or a bonded magnetic body is referred to as a bonded magnet or the like. However, in the present configuration, the bonded magnet or the like is considered to reach magnetic saturation due to an external magnetic field or a magnetic field from a small piece of a permanent magnet. In the case where the bonded magnet or the like reaches magnetic saturation, the relative magnetic permeability of the bonded magnet or the like is lowered to a value close to the relative magnetic permeability of air. Accordingly, the present configuration is equivalent to the state of having a layer of air, and thus, the increase in the magnetic flux density generated from the interior permanent magnet rotor cannot be expected.

Notably, a material having high saturated magnetic flux density and having a relative magnetic permeability higher than the relative magnetic permeability of air is useful for the material of a bonded magnet.

Patent Literature 2 discloses a technology relating to a bonded magnet of which relative magnetic permeability is increased.

Meanwhile, PTL 1 does not include the description relating to a relative magnetic permeability of a bonded magnet or a magnetic permeability of a bonded magnet.

Naturally, when a bonded magnet or the like is used, it is important to confirm the relative magnetic permeability of the bonded magnet or the like or an influence by the magnetic saturation or diamagnetic field.

### CITATION LIST

### Patent Literature

PTL 1: Unexamined Japanese Patent Publication No. H10-304610

PTL 2: International Publication No. 2012/157304

### SUMMARY OF THE INVENTION

An electric motor according to the present invention includes a stator, a rotor, and a pair of bearings.

The stator includes a stator core and a winding. The stator core is annularly formed. The winding is wound around the stator core, and a drive current is flown through the winding.

The rotor is located on the inner circumferential side of the stator core, and includes a shaft, a rotor core, and a bonded magnet. A shaft center of the shaft is located on an annular center axis of the stator core. The rotor core is mounted to the shaft to form a columnar body in the direction of the shaft center of the shaft. The rotor core includes an outer circumferential surface formed along the shaft center, and a plurality of magnet holes located along the outer circumferential surface. The bonded magnet is formed by mixing a magnet material and a resin material. The bonded magnet is filled in each of a plurality of magnet holes. When being filled in each of a plurality of magnet holes, the bonded magnet is formed with a high density portion having a high density and a low density portion having a density lower than the high density portion in the filling direction.

The pair of bearings is located to face each other across the rotor core. The pair of bearings supports the shaft so as to be rotatable.

In addition, the rotor has a plurality of d-axis magnetic flux paths and a plurality of q-axis magnetic flux paths. A plurality of d-axis magnetic flux paths generates magnet torque out of rotary torques generated on the rotor due to a rotating magnetic field generated by the stator, when a drive current flows through the winding. Similarly, a plurality of q-axis magnetic flux paths generates reluctance torque out of rotary torques.

Each of the d-axis magnetic flux paths is located to cross each of the plurality of bonded magnets. Each of the q-axis magnetic flux paths is located along each of the plurality of bonded magnets.

In the electric motor, the center position of the rotor core is located on the side where the high density portion is present with respect to the center position of the stator core in the direction of the shaft center of the shaft.

### BRIEF DESCRIPTION OF DRAWINGS

FIG. 1 is a perspective assembly view of a main part constituting an electric motor according to a first exemplary embodiment of the present invention.

FIG. 2 is a flowchart illustrating an assembly process of the main part constituting the electric motor according to the first exemplary embodiment of the present invention.

FIG. 3 is a sectional view illustrating an outline of the electric motor according to the first exemplary embodiment of the present invention.

FIG. 4 is an enlarged view of a key part of the electric motor illustrated in FIG. 3.

FIG. 5 is an explanatory view for describing a path of a magnetic flux generated on a rotor used in the electric motor according to the first exemplary embodiment of the present invention.

FIG. 6 is a plan view illustrating the rotor used in the electric motor according to the first exemplary embodiment of the present invention.

FIG. 7 is a sectional view illustrating an outline of another electric motor according to the first exemplary embodiment of the present invention.

FIG. 8 is a sectional view illustrating an outline of an electric motor according to a second exemplary embodiment of the present invention.

FIG. 9 is an enlarged view of a key part of the electric motor illustrated in FIG. 8.

FIG. 10 is a further enlarged view of the key part of the electric motor illustrated in FIG. 9.

FIG. 11 is a sectional view illustrating an outline of another electric motor according to the second exemplary embodiment of the present invention.

FIG. 12 is a diagram illustrating a configuration illustrating an outline of an electrical apparatus according to a third exemplary embodiment of the present invention.

### DESCRIPTION OF EMBODIMENTS

An electric motor according to exemplary embodiments of the present invention and an electrical apparatus provided with the same are able to prevent performance variation of a permanent magnet electric motor using bonded magnets according to the configuration described below. This is because the electric motor according to the present exemplary embodiments can provide consistent performance, even if the density of bonded magnets varies due to the insertion of a mixture constituting the bonded magnets.

Specifically, a conventional permanent magnet electric motor has the following structural problems to be improved. That is, in the case where an Nd—Fe—B sintered magnet having a high energy density is used as a small piece of a permanent magnet, an interior permanent magnet rotor becomes expensive.

Further, as described above, a gap is formed between a small piece of a permanent magnet embedded into an interior permanent magnet rotor and a magnet hole, and therefore, a loss is generated in a magnetic flux density generated from the interior permanent magnet rotor.

Furthermore, an interior permanent magnet rotor in which a bonded magnet is filled has the following problem to be improved. A magnet hole formed on a rotor core is formed along the center axis of the rotor core. A mixture constituting a bonded magnet is filled in the magnet hole from a filling opening formed on one side of the magnet hole. The filled mixture is cured to constitute the bonded magnet.

In the bonded magnet manufactured in the manner described above, the density of the bonded magnet on a portion distant from the filling opening is lower than the density of the bonded magnet on a portion closer to the filling opening.

Therefore, the bonded magnet varies in density. When the bonded magnet varies in density, a magnetic gradient according to the variation in density of the bonded magnet is generated in an amount of a magnetic flux generated from the bonded magnet in the direction of the center axis of the rotor core, i.e., the direction of the shaft center of the shaft. Therefore, magnetic attraction force caused by the magnetic gradient is generated on the rotor in the direction of the shaft center of the shaft.

Accordingly, even if the center position of the stator core and the center position of the rotor core are aligned with each other in assembling a permanent magnet electric motor, the center position of the stator core and the center position of the rotor core are deviated from each other due to the magnetic attraction force. The magnetic attraction force acts such that, in the direction of the shaft center of the shaft, the side of the filling opening where the density of the bonded magnet is high is attracted toward the side where the center position of the stator core is located.

Such permanent magnet electric motor cannot provide expected predetermined performance.

Exemplary embodiments of the present invention will be described below with reference to the drawings. Note that the exemplary embodiments described below are merely illustrative, and not restrictive of the technical scope of the present invention.

### First Exemplary Embodiment

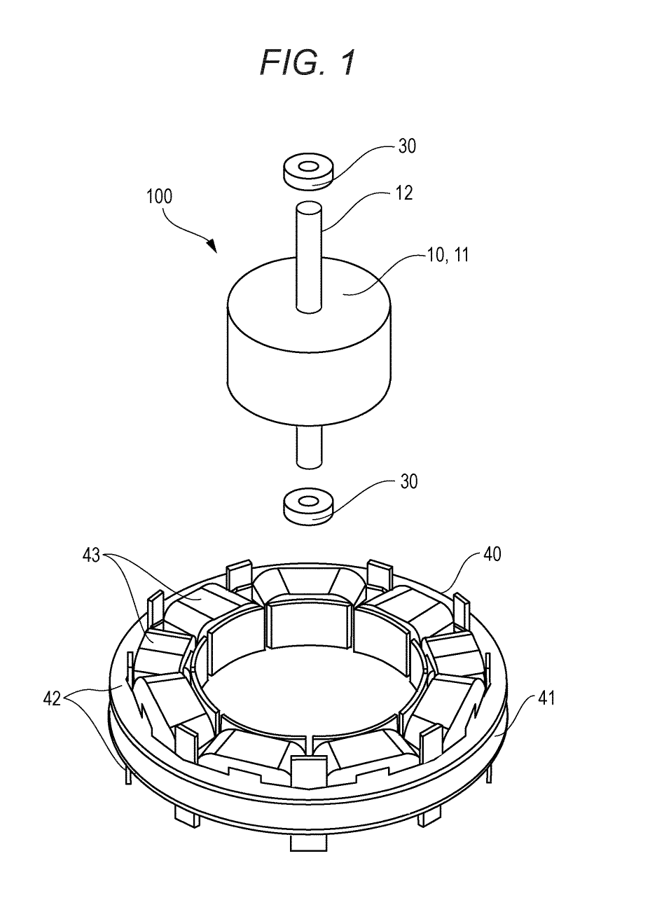

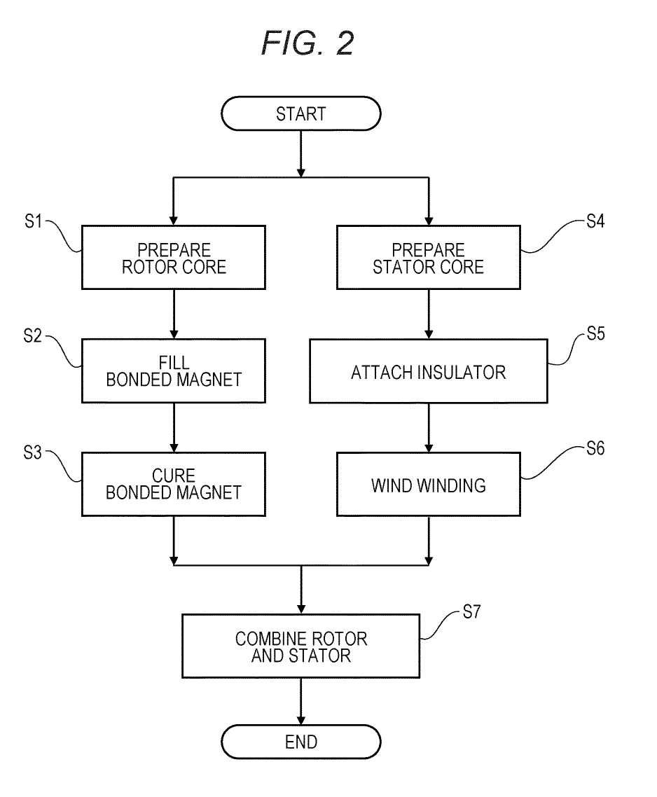

FIG. 1 is a perspective assembly view of a main part constituting an electric motor according to a first exemplary embodiment of the present invention. FIG. 2 is a flowchart illustrating an assembly process of the main part constituting the electric motor according to the first exemplary embodiment of the present invention.

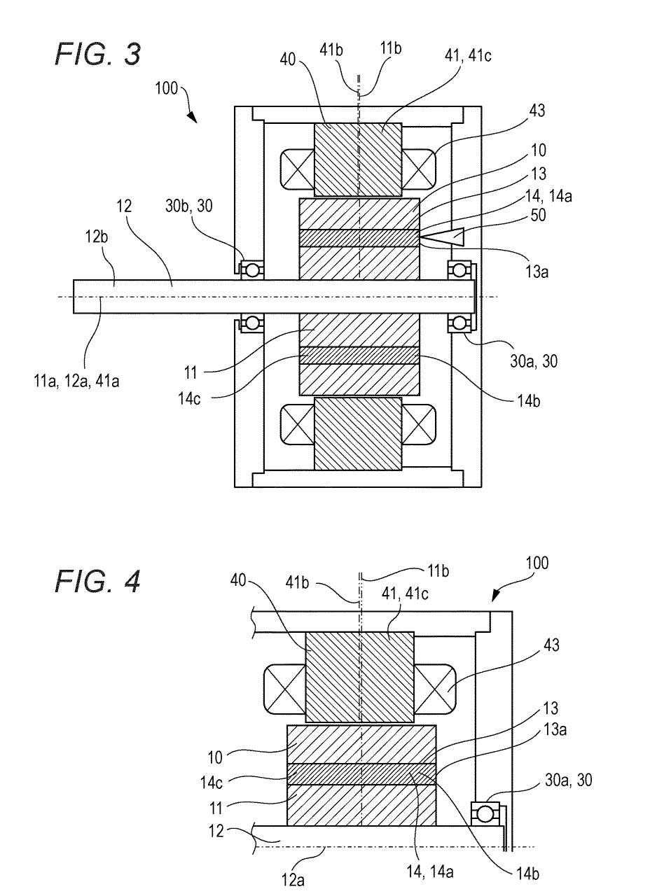

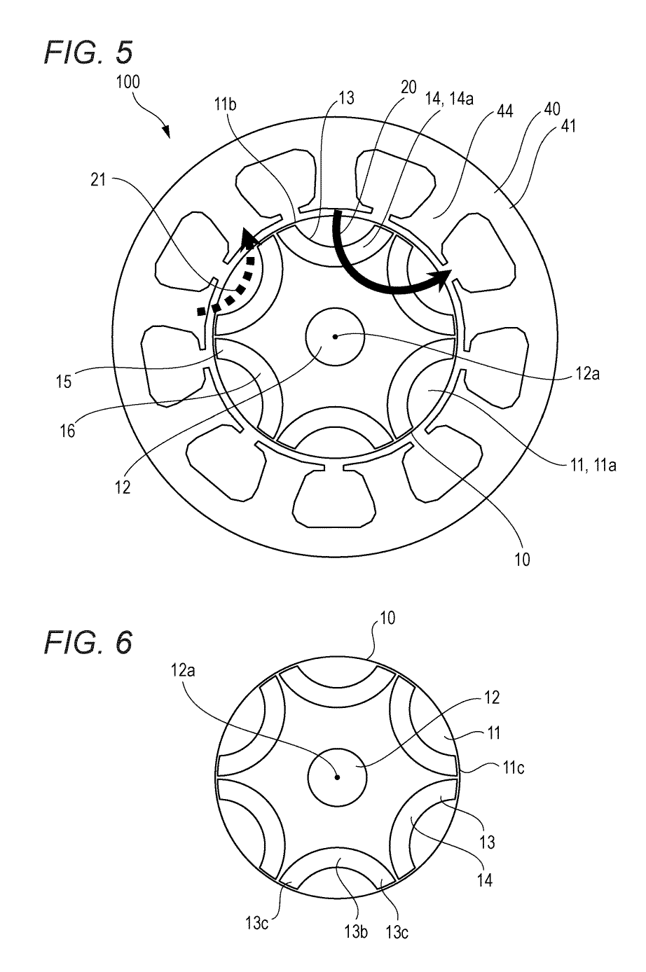

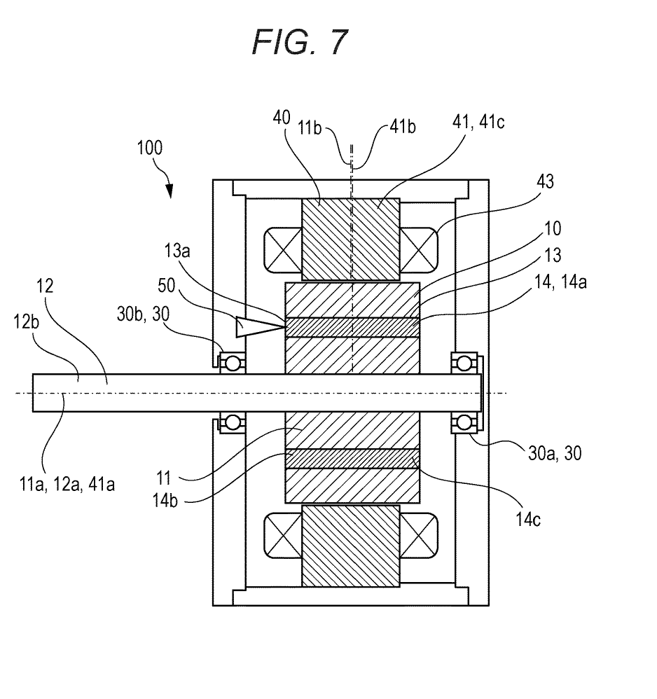

In addition, FIG. 3 is a sectional view illustrating the outline of the electric motor according to the first exemplary embodiment of the present invention. FIG. 4 is an enlarged view of a key part of the electric motor illustrated in FIG. 3. FIG. 5 is an explanatory view for describing a path of a magnetic flux generated on a rotor used in the electric motor according to the first exemplary embodiment of the present invention. FIG. 6 is a plan view illustrating the rotor used in the electric motor according to the first exemplary embodiment of the present invention. FIG. 7 is a sectional view illustrating an outline of another electric motor according to the first exemplary embodiment of the present invention.

Firstly, one example of a process of assembling the electric motor according to the first exemplary embodiment of the present invention will briefly be described with reference to FIGS. 1 and 2. Note that, in the description below, the electric motor is a permanent magnet electric motor as one example.

As illustrated in FIG. 1, electric motor 100 according to the first exemplary embodiment includes interior permanent magnet rotor 10 and stator 40. In the description below, interior permanent magnet rotor 10 is merely referred to as rotor 10 in some cases.

As illustrated in FIG. 2, rotor 10 and stator 40 are simultaneously prepared.

Firstly, rotor core 11 is prepared for rotor 10 (51). Thin steel plates constituting rotor core 11 are punched by a die. Each of the steel plates is punched by a die to form a magnet hole. Shaft 12 is inserted into each of a plurality of steel plates punched out by the die. The plurality of steel plates is laminated along the shaft center of shaft 12 to form rotor core 11.

Then, a mixture constituting a bonded magnet is filled in a magnet hole formed on rotor core 11 (S2). The mixture constituting the bonded magnet is used in the state in which magnet powders, resin material, and a small amount of additives are melted. The mixture constituting the bonded magnet is filled in the magnet hole from a gate provided on an insert fitting.

The mixture filled in rotor 10 is cured through a molding process to constitute a bonded magnet. During the molding process, a process according to the characteristic of the resin material included in the mixture is performed (S3).

The molding process indicates here a process for molding a bonded magnet. Particularly in the case where thermosetting resin is used as the resin material, the molding process includes the following processes. Specifically, the molding process includes a heating process for heating the mixture and melting the heated mixture. Since a thermosetting reaction is caused in the heated mixture, the mixture is cured. The cured mixture is cooled through a cooling process. The cooled mixture constitutes the bonded magnets.

In addition, in the case where thermoplastic resin is used as the resin material, the molding process includes the following processes. Specifically, the molding process includes a heating process for heating the mixture and melting the heated mixture. The heated mixture is cooled through a cooling process. The cooled mixture is re-cured to constitute the bonded magnets.

Note that, in the description below, the mixture constituting the bonded magnet is also referred to as a bonded magnet in some cases.

On the other hand, stator core 41 is prepared for stator 40 (S4). As in rotor core 11, stator core 41 is formed by laminating thin steel plates. Insulator 42 which is an insulating member is attached to stator core 41 (S5).

Next, a winding 43 through which a current flows is wound around stator core 41 to which insulator 42 is attached (S6).

Rotor 10 and stator 40, which are individually prepared, are combined to each other (S7).

As illustrated in FIG. 3, electric motor 100 according to the first exemplary embodiment includes rotor 10 inserted into stator 40 on an inner circumferential side with a gap. The main part of electric motor 100 will be described later. As illustrated in FIG. 1, when rotor 10 is inserted into stator 40, a pair of bearings 30 is attached to shaft 12 of rotor 10. Rotor 10 is rotatably supported by a pair of bearings 30.

Next, the electric motor according to the first exemplary embodiment of the present invention will be described in detail with reference to FIGS. 3 to 6. Note that only main components are hatched for facilitating understanding of the drawings.

As illustrated in FIGS. 3 and 4, electric motor 100 according to the first exemplary embodiment includes stator 40, rotor 10, and a pair of bearings 30.

Stator 40 includes stator core 41 and windings 43. Stator core 41 is annularly formed. Windings 43 are wound around stator core 41. A drive current is flown through windings 43. A core wire including any one of copper, copper alloy, aluminum, and aluminum alloy can be used for a core wire included in each of windings 43.

Rotor 10 is located on the inner circumferential side of stator core 41, and includes shaft 12, rotor core 11, and bonded magnets 14. Shaft center 12a of shaft 12 is located on annular center axis 41a of stator core 41. Rotor core 11 is mounted to shaft 12 to form a columnar body in the direction of shaft center 12a of shaft 12. As illustrated in FIG. 6, rotor core 11 includes outer circumferential surface 11c formed along shaft center 12a, and a plurality of magnet holes 13 located along outer circumferential surface 11c. Bonded magnet 14 is formed by mixing a magnet material and a resin material. As illustrated in FIG. 3, bonded magnet 14 is filled in each of a plurality of magnet holes 13. When being filled in each of a plurality of magnet holes 13, bonded magnet 14 is formed with high density portion 14b having a high density and low density portion 14c having a density lower than high density portion 14b in the filling direction.

A pair of bearings 30 is located to face each other across rotor core 11. A pair of bearings 30 supports shaft 12 so as to be rotatable.

In addition, as illustrated in FIG. 5, rotor 10 has a plurality of d-axis magnetic flux paths 20 and a plurality of q-axis magnetic flux paths 21. A plurality of d-axis magnetic flux paths 20 generates magnet torque out of rotary torques generated on rotor 10 due to a rotating magnetic field generated by stator 40, when a drive current flows through windings (43). Similarly, a plurality of q-axis magnetic flux paths 21 generates reluctance torque out of rotary torques.

Each of d-axis magnetic flux paths 20 is located to cross each of the plurality of bonded magnets 14. Each of q-axis magnetic flux paths 21 is located along each of the plurality of bonded magnets 14.

As illustrated in FIGS. 3 and 4, in electric motor 100, center position 11b of rotor core 11 is located on the side where high density portion 14b is present with respect to center position 41b of stator core 41 in the direction of shaft center 12a of shaft 12.

The electric motor according to the first exemplary embodiment will be described in more detail with reference to the drawings.

As illustrated in FIG. 3, electric motor 100 includes stator 40 and rotor 10. Stator 40 includes stator core 41 and windings 43 wound around stator core 41. Rotor 10 is located on the inner circumferential side of stator 40. Rotor 10 is located in stator 40 with a slight gap formed therebetween.

Rotor 10 includes rotor core 11, shaft 12, and bonded magnets 14 that are permanent magnets. Rotor core 11 is formed by laminating a plurality of steel plates 41c, which is punched out, in the direction of shaft center 12a of shaft 12. Shaft 12 is attached to rotor core 11. Bonded magnets 14 are filled in a plurality of magnet holes 13 formed on rotor core 11.

A pair of bearings 30 supports shaft 12 so as to be rotatable.

Rotor 10 according to the first exemplary embodiment will be described here.

As illustrated in FIG. 6, rotor core 11 has a plurality of magnet holes 13 formed along outer circumferential surface 11c of rotor core 11 at regular intervals. Each of magnet holes 13 has an arc shape protruding toward shaft 12 from outer circumferential surface 11c. Specifically, each of magnet holes 13 has a protruding central part 13b and both ends 13c located near outer circumferential surface 11c.

As illustrated in FIG. 3, mixture 14a constituting bonded magnet 14 is used in the state in which a magnet material, a resin material, and a plurality of additives are melted. Mixture 14a constituting bonded magnets 14 is filled into magnet holes 13 from gate 50, which is an insert metal fitting, through filling opening 13a. After mixture 14a is filled in magnet holes 13, a molding process is performed to cure bonded magnets 14. In general, the molding process includes a process for applying pressure to filled mixture 14a.

As described above, particularly in the case where thermosetting resin is used as the resin material, the molding process includes the following processes. Specifically, the molding process includes a heating process for heating the mixture and melting the heated mixture. Since a thermosetting reaction is caused in the heated mixture, the mixture is cured. The cured mixture is cooled through a cooling process. The cooled mixture constitutes the bonded magnets.

In addition, in the case where thermoplastic resin is used as the resin material, the molding process includes the following processes. Specifically, the molding process includes a heating process for heating the mixture and melting the heated mixture. The heated mixture is cooled through a cooling process. The cooled mixture is re-cured to constitute the bonded magnets.

Notably, FIG. 3 illustrates that mixture 14a constituting bonded magnets 14 is filled from gate 50 with rotor 10 and stator 40 being combined to each other. FIG. 3 clearly illustrates the later-described feature of electric motor 100 according to the first exemplary embodiment. During an actual manufacturing process, mixture 14a constituting bonded magnets 14 is filled into magnet holes 13 on rotor 10 which has been prepared alone.

Further, even if filling opening 13a from which mixture 14a constituting bonded magnets 14 is filled is located close to output shaft 12b as illustrated in FIG. 7, the similar operation and effect can be obtained. In this case, center position 11b of rotor core 11 is located on the side of filling opening 13a with respect to center position 41b of stator core 41 in the direction of shaft center 12a.

Note that the first exemplary embodiment does not exclude the configuration of filling mixture 14a, which constitutes bonded magnets 14, into magnet holes 13 with rotor 10 being combined to stator 40 in electric motor 100.

In manufacturing rotor 10, mixture 14a constituting bonded magnets 14 is filled into magnet holes 13 from gate 50, which is an insert metal fitting, through filling opening 13a. As described above, mixture 14a constituting bonded magnets 14 to be inserted is formed by mixing a magnet material, a resin material, and a small amount of additives. In this case, filling pressure applied to mixture 14a is not uniform in magnet holes 13. Specifically, in mixture 14a filled in each of magnet holes 13 in the state of being melted, the density of the portion of the bonded magnet on the side opposite to filling opening 13a is lower than the density of the portion of the bonded magnet on the side closer to filling opening 13a.

Accordingly, the density varies in bonded magnet 14 filled in each of magnet holes 13. Thus, bonded magnet 14 has a magnetic gradient such that an amount of magnetic flux is decreased toward the side opposite to filling opening 13a from the side where filling opening 13a is provided in the direction of shaft center 12a. The magnetic gradient generates magnetic attraction force exerted in the direction of shaft center 12a.

In general, this magnetic attraction force causes misalignment between a stator and a rotor. That is, a stator and a rotor are combined to each other to form an electric motor in such a way that the center position of the stator core and the center position of the rotor core have a predetermined relationship. Since the magnetic attraction force is exerted after the stator and the rotor are combined to each other, the stator core and the rotor core cannot keep the predetermined relationship between the center position of the stator core and the center position of the rotor core. In other words, the electric motor has a deviation in the positional relation between the center position of the stator core and the center position of the rotor core. Due to this deviation, the electric motor cannot provide expected predetermined characteristics.

In view of this, as illustrated in FIGS. 3 and 4, electric motor 100 according to the first exemplary embodiment is assembled such that center position 11b of rotor core 11 is deviated in the direction of shaft center 12a with respect to center position 41b of stator core 41 according to the magnetic gradient.

Specifically, electric motor 100 according to the first exemplary embodiment is assembled such that center position 11b of rotor core 11 is deviated toward filling opening 13a with respect to center position 41b of stator core 41 in the direction of shaft center 12a.

In other words, electric motor 100 is assembled such that center position 11b of rotor core 11 is deviated toward filling opening 13a in the direction of shaft center 12a with respect to center position 41b of stator core 41 according to the variation in density of bonded magnet 14 filled in each of magnet holes 13.

Thus, electric motor 100 can provide consistent performance even if the magnetic attraction force caused by the magnetic gradient is exerted on rotor core 11 in the direction of shaft center 12a.

Specifically, in electric motor 100, rotor 10 is provided on an inner circumferential side of stator 40. Electric motor 100 is assembled in such a way that center position 11b of rotor core 11 is deviated toward filling opening 13a in the direction of shaft center 12a with respect to center position 41b of stator core 41 by the distance according to the magnetic gradient.

After electric motor 100 is assembled, magnetic attraction force for attracting rotor core 11 toward output shaft 12b is exerted on rotor core 10. Thus, in electric motor 100, center position 11b of rotor core 11 is aligned with center position 41b of stator core 41 in the direction of shaft center 12a.

If center position 11b of rotor core 11 and center position 41b of stator core 41 are aligned with each other in the direction of shaft center 12a, interacting magnetic force between rotor 10 and stator core 40 can be used with minimal loss. Accordingly, energy efficiency is enhanced, and the characteristics are also stabilized in electric motor 100.

Note that, in the description above, filling opening 13a is located on the side opposite to output shaft 12b in electric motor 100 illustrated in FIG. 3.

The technical scope of the present invention is not limited to this configuration. Specifically, even if filling opening 13a is located on the side close to output shaft 12b as illustrated in FIG. 7, electric motor 100 can provide the similar operation and effect. In this case, center position 11b of rotor core 11 is located on the side of filling opening 13a with respect to center position 41b of stator core 41 in the direction of shaft center 12a.

Further, rotor 10 illustrated in FIG. 6 has six poles. That is, the number of magnet holes 13 is six.

The technical scope of the present invention encompasses a rotor with another number of poles. Specifically, when n is defined as a natural number, the technical scope of the present invention encompasses a rotor with 2n poles.

For example, in an electric motor in which windings are wound around a stator core in a concentrated manner, the similar operation and effect can be obtained with the following combinations of the number of poles and the number of slots. Specifically, examples of the combination of the number of poles and the number of slots include the combination of ten poles and nine slots, the combination of ten poles and twelve slots, the combination of twelve poles and nine slots, and the combination of fourteen poles and twelve slots.

Further, in an electric motor in which windings are wound around a stator core in a distributed manner, the similar operation and effect can be obtained with the following combinations of the number of poles and the number of slots. Specifically, examples of the combination of the number of poles and the number of slots include the combination of four poles and twenty-four slots, the combination of four poles and thirty-six slots, the combination of six poles and thirty-six slots, and the combination of eight poles and forty-eight slots.

Further, in an electric motor in which windings are wound around a stator core like a wave, the similar operation and effect can be obtained with the following combinations of the number of poles and the number of slots. Specifically, examples of the combination of the number of poles and the number of slots include the combination of four poles and twelve slots and the combination of six poles and eighteen slots.

In addition, rotor 10 illustrated in FIG. 6 has arc-shaped magnet holes 13.

The technical scope of the present invention encompasses a magnet hole with other shapes. Specifically, even if the magnet hole has an arc shape with two or more different curvatures, the similar operation and effect can be obtained. Besides, the similar operation and effect can be obtained, even if the magnet hole has a V shape, a U shape, or a U shape with cornered bottom.

### Second Exemplary Embodiment

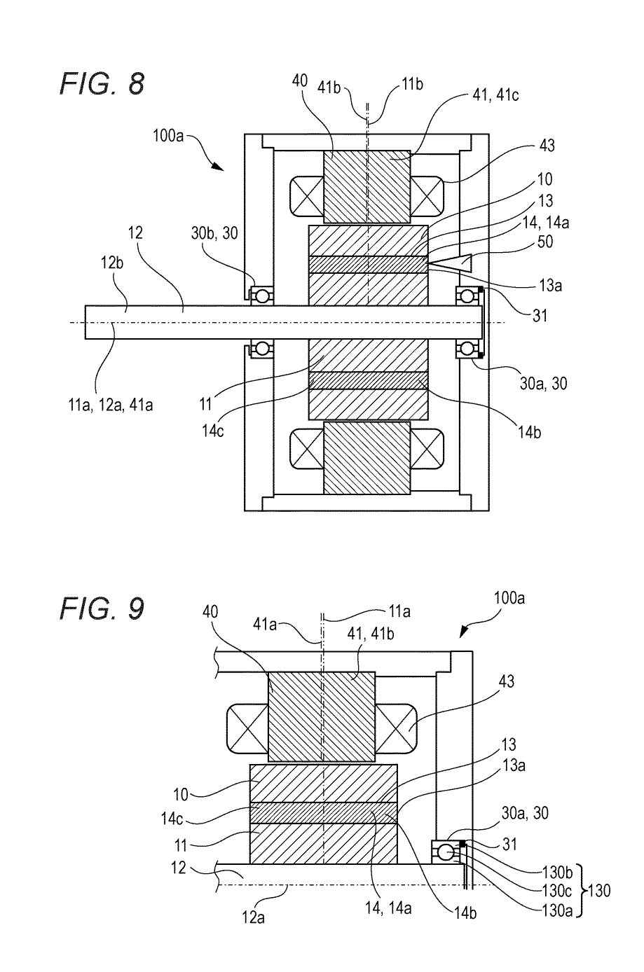

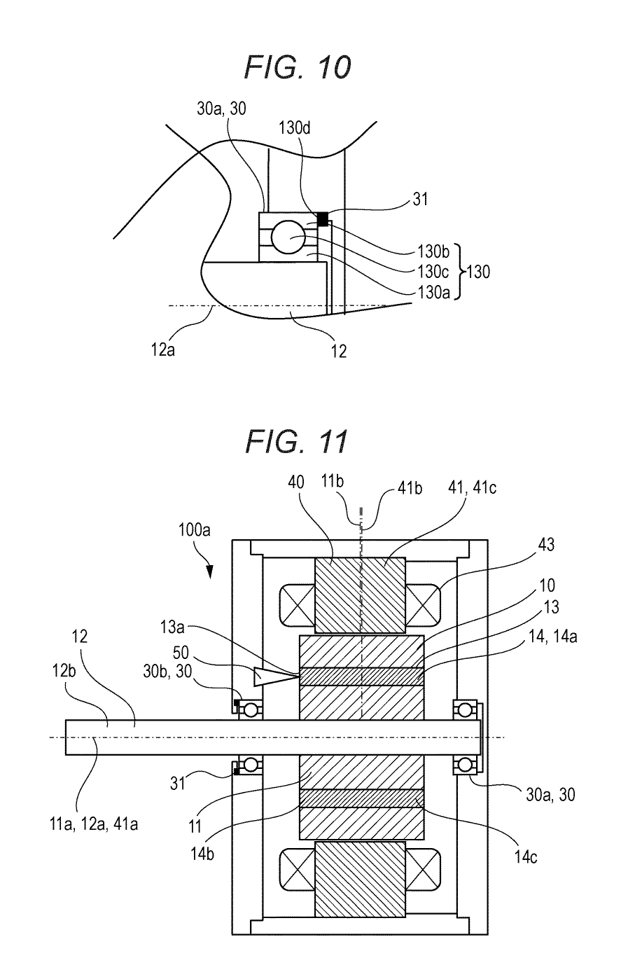

FIG. 8 is a sectional view illustrating an outline of an electric motor according to a second exemplary embodiment of the present invention. FIG. 9 is an enlarged view of a key part of the electric motor illustrated in FIG. 8. FIG. 10 is a further enlarged view of the key part of the electric motor illustrated in FIG. 9. FIG. 11 is a sectional view illustrating an outline of another electric motor according to the second exemplary embodiment of the present invention.

Note that the same components as those in the electric motor in the first exemplary embodiment are identified by the same reference numerals, and the description for them in the first exemplary embodiment will be applied.

As illustrated in FIGS. 8 to 10, electric motor 100a according to the second exemplary embodiment of the present invention includes the following configuration in addition to the configuration of electric motor 100 described in the first exemplary embodiment.

Specifically, bearing 30a located on the side where high density portion 14b is present, out of a pair of bearings 30, has pressure mechanism 31. Pressure mechanism 31 presses rotor core 11 toward the side where low density portion 14c is present in the direction of shaft center 12a of shaft 12.

Particularly, pressure mechanism 31 is formed of an elastic body.

Further, the exemplary embodiment providing significant operation and effects are as stated below.

Specifically, as illustrated in FIGS. 9 and 10, bearing 30a located on the side where filling opening 13a is provided, i.e., on the side where high density portion 14b is present, out of a pair of bearings 30, is ball bearing 130. Ball bearing 130 includes inner race 130a, outer race 130b, and balls 130c. Inner race 130a is attached to shaft 12. Outer race 130b is located to face inner race 130a. A plurality of balls 130c are located between inner race 130a and outer race 130b.

Outer race 130b has elastic body (31) in the direction of shaft center 12a of shaft 12. Elastic body (31) presses rotor core 11 toward the side opposite to the side where filling opening 13a is located, i.e., toward the side where low density portion 14c is present. Elastic body (31) is attached on end face 130d of outer race 130b opposite to the side where filling opening 13a is located.

The electric motor according to the second exemplary embodiment will be described in more detail with reference to the drawings.

As illustrated in FIG. 8, electric motor 100a includes pressure mechanism 31 on bearing 30a located on the side where filling opening 13a is provided in the direction of shaft center 12a. Pressure mechanism 31 presses rotor core 10 toward the side opposite to filling opening 13a from the side of filling opening 13a in the direction of shaft center 12a.

That is, the phenomenon described below may occur in the first exemplary embodiment.

Specifically, in electric motor 100, magnetic attraction force caused by a magnetic gradient is exerted on rotor core 11 in the direction of shaft center 12a. In electric motor 100, this magnetic attraction force allows center position 11b of rotor core 11 to be aligned with center position 41b of stator core 41 in the direction of shaft center 12a.

Meanwhile, electric motor 100 described in the first exemplary embodiment has the configuration in which the positional relation between rotor 10 and stator 40 is kept by magnetic force that is magnetic attraction force.

In the present exemplary embodiment, while electric motor 100 is driven, rotor 10 may vibrate in the direction of shaft center 12a. The vibration of rotor 10 causes vibration of electric motor 100. Alternatively, the vibration of rotor 10 causes noise generated from electric motor 100.

In view of this, electric motor 100a according to the second exemplary embodiment has pressure mechanism 31 as physical means.

Specifically, during the assembly of rotor 10 into the inner circumferential side of stator 40 to produce electric motor 100a, the process described below is performed.

Firstly, electric motor 100a is assembled such that center position 11b of rotor core 11 is deviated toward filling opening 13a, that is, toward the side where high density portion 14b is present, with respect to center position 41b of stator core 41 in the direction of shaft center 12a.

In addition, electric motor 100a is provided with pressure mechanism 31 on bearing 30a located on the side where filling opening 13a is provided in the direction of shaft center 12a. Pressure mechanism 31 is attached in such a way that bearing 30a applies force for pressing rotor 10 toward output shaft 12b in the direction of shaft center 12a.

The configuration in which bearing 30a is ball bearing 130 is illustrated in FIGS. 9 and 10 as a specific example.

Ball bearing 130 includes inner race 130a, outer race 130b, and balls 130c. Inner race 130a is attached to shaft 12. Outer race 130b is located to face inner race 130a. Balls 130c are located between inner race 130a and outer race 130b.

Pressure mechanism 31 is attached on end face 130d of outer race 130b located on the side opposite to the end face facing filling opening 13a in the direction of shaft center 12a.

According to this configuration, pressure mechanism 31 presses rotor 10 toward output shaft 12b through ball bearing 130.

Accordingly, electric motor 100a according to the second exemplary embodiment can keep the relationship between rotor 10 and stator 40 in the direction of shaft center 12a with two forces, even if magnetic attraction force caused by a magnetic gradient generated on bonded magnets 14 is generated.

Specifically, one of two forces is magnetic attraction force described in the first exemplary embodiment. Electric motor 100a is assembled in such a way that center position 11b of rotor core 11 is deviated from center position 41b of stator core 41 in the direction of shaft center 12a. Magnetic attraction force is exerted to allow center position 11b of rotor core 11 to be aligned with center position 41b of stator core 41.

The other of two forces is pressing force by pressure mechanism 31 described above. The pressing force presses rotor 10 toward output shaft 12b in the direction of shaft center 12a.

Due to two forces described above, electric motor 100a according to the second exemplary embodiment can stably keep the positional relation between rotor 10 and stator 40 even while electric motor 100a is driven.

Particularly, pressure mechanism 31 is formed of an elastic body. Specific examples of the elastic body include a spring washer and a conical spring washer. Other members can also be used, so long as they provide the similar operation and effect.

According to this configuration, even if vibration of rotor 10 occurs in the direction of shaft center 12a due to the magnetic attraction force, the elastic body absorbs this vibration. Therefore, electric motor 100a provides consistent performance and is driven with low vibration and low noise.

Note that, in the description above, filling opening 13a is located on the side opposite to output shaft 12b in electric motor 100a illustrated in FIG. 8.

The technical scope of the present invention is not limited to this configuration. Specifically, even if filling opening 13a is located on the side close to output shaft 12b as illustrated in FIG. 11, electric motor 100a can provide the similar operation and effect. In this case, pressure mechanism 31 is attached to bearing 30b located on the side of output shaft 12b. In addition, center position 11b of rotor core 11 in the direction of shaft center 12a is located on the side closer to filling opening 13a with respect to center position 41b of stator core 41.

### Third Exemplary Embodiment

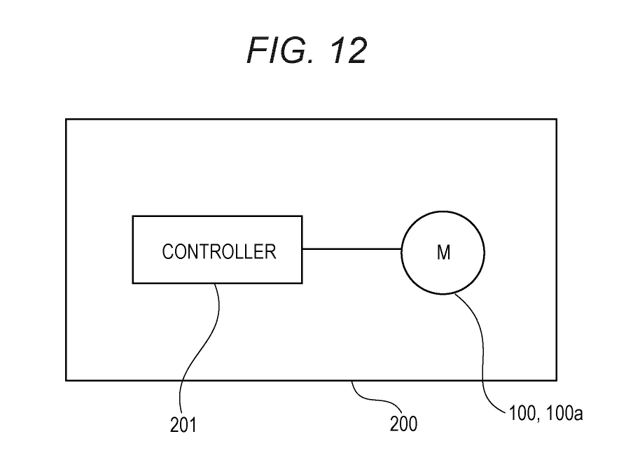

FIG. 12 is a diagram illustrating a configuration illustrating an outline of an electrical apparatus according to a third exemplary embodiment of the present invention.

Note that the components same as those in the electric motors in the first and second exemplary embodiments are identified by the same reference numerals, and the description for them in the first and second exemplary embodiments will be applied.

As illustrated in FIG. 12, electrical apparatus 200 according to the third exemplary embodiment of the present invention includes electric motor 100 described in the first exemplary embodiment and controller 201 controlling electric motor 100.

Alternatively, electrical apparatus 200 according to the third exemplary embodiment of the present invention includes electric motor 100a described in the second exemplary embodiment and controller 201 controlling electric motor 100a.

According to this configuration, electrical apparatus 200 that provides the operation and effect described in the first and second exemplary embodiments can be obtained.

Specifically, electrical apparatus 200 is a home electrical appliance such as an air conditioner. Electrical apparatus 200 is also an industrial machine such as a robot.

### INDUSTRIAL APPLICABILITY

An electric motor according to the present invention can provide consistent performance, even if the density of bonded magnets varies due to the insertion of a mixture constituting the bonded magnets. The use of the electric motor according to the present invention is not particularly limited. The electric motor according to the present invention is applicable to various electrical apparatuses including electric home appliances such as an air conditioner, and industrial machines such as a robot.

### REFERENCE MARKS IN THE DRAWINGS

10: rotor (interior permanent magnet rotor)
11: rotor core
11a: center axis
11b, 41b: center position
11c: outer circumferential surface
12: shaft
12a: shaft center
12b: output shaft
13: magnet hole
13a: filling opening
13b: central part
13c: end
14: bonded magnet
14a: mixture
14b: high density portion
14c: low density portion
20: d-axis magnetic flux path
21: q-axis magnetic flux path
30, 30a, 30b: bearing
31: pressure mechanism (elastic body)
40: stator
41: stator core
41a: annular center axis
41c: steel plate
42: insulator
43: winding
50: gate
100, 100a: electric motor
130: ball bearing
130a: inner race
130b: outer race
130c: ball
130d: end face
200: electrical apparatus
201: controller

1. An electric motor comprising:
a stator including:
a stator core which is annularly formed; and
a winding which is wound around the stator core and through which a drive current flows;
a rotor located on an inner circumferential side of the stator core and including:
a shaft which has a shaft center located on an annular center axis of the stator core;
a rotor core which is attached to the shaft to form a columnar body in a direction of the shaft center of the shaft, and includes an outer circumferential surface formed along the shaft center and a plurality of magnet holes located along the outer circumferential surface; and
a bonded magnet which is formed by mixing a magnet material and a resin material, filled in each of the plurality of magnet holes, and formed with a high density portion having a high density and a low density portion having a density lower than the high density portion in a filling direction when being filled in each of the plurality of magnet holes; and
a pair of bearings that is located across the rotor core and supports the shaft so as to be rotatable,
wherein the rotor has:
a plurality of d-axis magnetic flux paths that generates magnet torque, out of rotary torques generated on the rotor due to a rotating magnetic field generated by the stator, when the drive current flows through the winding; and
a plurality of q-axis magnetic flux paths that generates reluctance torque out of the rotary torques,
wherein each of the d-axis magnetic flux paths is located to cross each of the plurality of bonded magnets, each of the q-axis magnetic flux paths is located along each of the plurality of bonded magnets, and a center position of the rotor core is located on a side where the high density portion is present with respect to a center position of the stator core in the direction of the shaft center.

2. The electric motor according to claim 1, wherein one of the pair of bearings located on the side where the high density portion is present includes a pressure mechanism that presses the rotor core toward a side where the low density portion is present in the direction of the shaft center.

3. The electric motor according to claim 2, wherein the pressure mechanism is formed of an elastic body.

4. The electric motor according to claim 1, wherein one of the pair of bearings located on the side where the high density portion is present is a ball bearing including:
an inner race attached to the shaft;
an outer race located to oppose the inner race; and
a plurality of balls located between the inner race and the outer race,
wherein in the direction of the shaft center, the outer race includes an elastic body, which presses the rotor core toward a side where the low density portion is present and is mounted on an end face of the outer race on the side where the low density portion is present.

5. An electrical apparatus comprising:
the electric motor according to claim 1; and
a controller that controls the electric motor.
